(19) United States
(12) Patent Application Publication
(10) Pub. No.: US 2024/0253993 A1
(43) Pub. Date: Aug. 1, 2024

(54) A METHOD FOR PREPARING GRAPHENE-BASED FILMS USING LASER SOURCES

(71) Applicant: FOUNDATION FOR RESEARCH AND TECHNOLOGY HELLAS - INSTITUTE OF CHEMICAL ENGINEERING SCIENCES (FORTH/IC, Rio-Patras (GR)

(72) Inventors: Spyros N. YANNOPOULOS, Rio-Patras (GR); Kapil BHORKAR, Rio-Patras (GR); Nikolaos SAMARTZIS, Rio-Patras (GR); Michail ATHANASIOU, Rio-Patras (GR); Vassileios DRACOPOULOS, Rio-Patras (GR); Theophilos IOANNIDES, Rio-Patras (GR)

(21) Appl. No.: 18/559,806

(22) PCT Filed: May 11, 2021
(86) PCT No.: PCT/GR2021/000029

§ 371 Date: Nov. 9, 2023

(51) Int. Cl. C01B 32/184; B05D 7/24; H01G 11/36; H01G 11/86; H02N 1/04

(52) U.S. Cl. CPC C01B 32/184; B05D 7/24; H01G 11/36; H01G 11/86; H02N 1/04

(57) ABSTRACT

Disclosed herein methods for the Laser-assisted Explosion Synthesis and simultaneous Transfer (LEST) of few-layer turbostratic graphene and graphene-based nanohybrids onto any substrate. Industrially scalable laser-assisted methods of fabricating turbostratic graphene by irradiating carbon-containing compounds (e.g. polymers, organic compounds, biomass-derived products, graphitic materials and their combinations). Laser-assisted methods for preparation of turbostratic graphene/inorganic nanoparticles hybrids. The disclosed processes are versatile as they operate at ambient (atmospheric) environment and through single lasing irradiation at the cm-scale spot size. LEST is capable of producing, and simultaneously transferring, turbostratic graphene on any substrate, such as polymer, glass, carbon paper, metal, ceramic, and so on, avoiding intermediate transfer steps and chemical treatment. In some embodiments LEST graphene has been used to prepare high-performance electrodes for triboelectric nanogenerators and supercapacitors. The resulting turbostratic graphene and graphene-based nanohybrids can be used, inter alia, as electrodes in energy conversion and storage devices, in flexible electronic devices, sensors, filters, photocatalytic reactors, etc.

### BACKGROUND

### Technical Field of Invention

The present invention relates to a method of Laser-assisted Explosion Synthesis and simultaneous Transfer (LEST) of turbostratic graphene and graphene-based nanohybrids onto any substrate, by irradiating carbon-containing compounds and selected precursor materials. The invention proposes an uncomplicated and scalable process to prepare high-quality graphene and graphene/nanoparticles nanohybrids employing laser-assisted decomposition of various types of carbon sources such as, but not limited to, polymers, organic compounds, biomass-derived products and their combinations with other inorganic precursors. The process is versatile as it operates at atmospheric environment and through single lase irradiation at the cm-scale spot size. LEST is capable of producing, and simultaneously transferring, graphene on any substrate, such as polymer, glass, carbon paper, metal, ceramic, and so on, avoiding intermediate steps of chemical treatment. It should be appreciated that the above substrates are exemplary and the teachings of this disclosure may be applied to any substrate desired. The resulting graphene and graphene-based nanohybrids can be used, inter alia, as electrodes in energy conversion and storage devices, in electronic devices, sensors, filters, etc.

### Background of Invention

Graphene and graphene-related materials (GRMs) have profoundly dominated in science and technology over one and a half decade.^{1,2} These materials have attracted particular attention owing to the supreme properties of monolayer graphene, which raised great expectations for a number of applications. Indeed, GRMs have been explored for a wide range of applications, including primarily microelectronics,³ and other sectors as well, ranging from sensors, membranes, flexible electronics, energy conversion/storage devices, various functional coatings, up to concrete additives.⁴ However, in their vast majority, real-world viable applications of graphene have remained rather unachieved or at least have not reached the level foreseen a decade ago.⁵ The main cause has been the inadequacy of the current synthesis methods to scale up production of graphene with appropriate quality. The trade-off between quality and scalability has evolved towards the development of graphene-like structures or GRMs suitable for less-demanding applications placing the emphasis on particles, platelets and 3D graphene structures, such as foams and porous networks. Selected commercial products, e.g. sports goods, inks and coatings, are currently using GRMs as additives.⁶

Laser-based methods for graphene and GRMs synthesis have been less employed over the first decade of the graphene era, in comparison to conventional wet-chemistry and high-temperature vacuum chamber methods. The sporadic attempts of use of lasers appearing initially have gained ground over the last years in view of the versatility offered by the use of lasers and their success in a wide variety of processes including epitaxial growth on SiC wafers,⁷ and SiC particles,⁸ decomposition of polymers,⁹ and biomass,^{10,11} reduction of graphene oxide,^{12,13} transformation of carbon materials from sp³ to sp² networks,¹⁴ and so on.¹⁵

Graphitization of commercial polymers such as polyimide (PI), known as Kapton,¹⁰ has led to the upsurge a large number of similar studies, where laser-assisted graphene growth on Kapton foils has been explored for different applications.¹⁶ However, the main shortcoming of such studies is that graphene film is attached on the Kapton foil, as only a surface layer of the foil is converted by laser to graphene film. This limits the use of graphene supported on Kapton foils for a wide spectrum of applications that require transferring the graphene onto another substrate. To alleviate this problem, a recent report makes use of two different lasers; one is used to grow graphene films on Kapton foil surfaces, while the second is used to transfer graphene on another substrate.¹⁷

Graphene-based nanohybrids, typically GRMs blended with other types of nanoparticles, have been under focus as they can offer additional functionalities brought about by the combination and synergies of the properties of the individual components. Synthesis approaches of GRM nanohybrids typically entail various chemical methods such as hydrothermal, sol-gel, layer-by-layer, and so on, where in most cases the two components are prepared separately before being blended. These approaches require complex and time-consuming steps followed by elaborate post-treatment procedures, which unavoidably contaminate the purified material with residues affecting performance and durability of the device application. Representative examples of nanohybrids based on graphene and silica, include chemically reduced GO and Stöber-prepared SiO₂ nanoparticles to prepare rGO/SiO₂ for photocatalytic applications,¹⁸ rGO/SiO₂ solid films (prepared by spin-coating dispersion of GO containing silica precursors followed by chemical reduction and calcination to produce rGO and SiO₂, respectively) as transparent conductors,¹⁹ and gas sensors.²⁰ GRM/SiOₓ hybrids have also shown very promising potential in microwave absorption and electromagnetic shielding, in view of the synergistic effects of dielectric and magnetic loss brought about by hybridization.²¹

The first attempt on transfer of graphene to a substrate by laser-induced forward transfer (LIFT) has recently been reported by Smits et al.²² Graphene was first grown by chemical vapor deposition (CVD) and manually transferred onto a glass surface, which was then covered by triazene. The LIFT process took place via the laser-assisted decomposition of triazene, where the produced N₂ gas propelled graphene layers to the substrate. This method differs substantially from the current disclosure because it is based on graphene growth by other high-temperature methods (CVD) and the manual transfer of graphene by wet-chemistry steps; overall the method being not applicable to large scale simultaneous growth and transfer.

While the invention is susceptible to various modifications and alternative forms, specific embodiment thereof has been shown by way of example in the drawings and will be described in detail below. It should be understood, however that it is not intended to limit the invention to the particular forms disclosed, but on the contrary, the invention is to cover all modifications, equivalents, and alternatives falling within the spirit and the scope of the invention.

### SUMMARY OF INVENTION

### Technical Problem

The current invention provides a method by which a wide range of carbon sources can be converted to high-quality graphene and graphene-based structures by single lase irradiation and simultaneously be transferred by the explosive mechanism of the carbon source decomposition, onto the surface of any type of substrate selected according to the desired application. The disclosed method resolves certain major shortcomings related to graphene and graphene-based materials synthesis and manipulation—including graphene quality and transfer—by conventional current methods.

At present, industrial production has not managed to bear up with the specified quality of graphene and GRMs suitable to particular needs, as noted in a recent report co-authored by the Nobel laureate (K. Novoselov) for graphene discovery.²³ Commercially, GRMs are produced today with varying properties spanning a range of quality from graphene-like to graphite-like. As a result, production of GRMs at large volume with consistent quality is still elusive, stalling progress in their integration into devices. Indeed, a recent scrutiny concerning “commercial graphene” powders produced by more than sixty companies worldwide, concluded that they predominantly consist of graphite particles.²³ This study advocates that the poor quality of the commercial “graphene” is the main source of the long delay of pertinent applications. We briefly provide below certain shortcomings about high-quality graphene synthesis and production.

First, large scale graphene synthesis is currently pursued along two main directions: (a) liquid exfoliation of graphite powders and (b) CVD operating at high temperature in tube furnace. Both methods are associated with certain drawbacks that limit flexibility in graphene transfer and use thereof. Liquid exfoliation makes use of harmful solvents and inextricable purification procedures requiring long term processing. More importantly, the solvent evaporation after exfoliation leads to restacking of the mono- and few-layer particles to multilayer platelets, which have essentially the properties of micro-crystalline graphite.²³ CVD is currently employed to prepare mono- or bi-layer graphene films on a copper foil, in a continuous R2R manufacturing process. Complex processes are required to transfer graphene, which include several steps, i.e. (1) coating a protective layer (e.g. PMMA) on one side, (2) etching graphene on the other side, (3) etching away the copper by some acid, (4) transferring to target substrate, and (5) removal of protective film, by typically using solvent to dissolve it.

Second, although a number of laser-assisted approaches have been employed for graphene synthesis in the prior art,²⁴ there is no established method yet as to prepare high-quality turbostratic graphene using a single-step, laser-assisted synthesis growth, by irradiating various carbon sources at ambient conditions. At present, laser-based methods have not yet managed to demonstrate turbostratic graphene growth, resulting solely to few- or multi-layer Bernal-stacked graphene. Avoiding Bernal stacking by the introduction of either rotational faults between adjacent layers or expanding the interlayer spacing or both, leads to the formation of turbostratic stacking. Turbostratic structure is a key issue for retaining a high conductivity of few-layer or even multi-layer graphene due to the decoupling of adjacent graphene layers.^{25,26} Turbostratic graphene can be obtained by flash Joule heating at very high temperature, i.e. 3000 K.²⁷ However, this method is capable of producing graphene powders, which have to be dispersed in liquid media for further use; while the current disclosure tackles the issue of high-quality turbostratic few-layer graphene synthesis and simultaneous transfer on any type of substrate at a single lase irradiation.

A third shortcoming of the prior art, which is tackled by the current invention, is related to the simultaneous laser-assisted carbon source decomposition and forward transfer of the carbon fragments directly onto the surface of a substrate of any type forming turbostratic graphene. Current laser-based methods have been focused on the direct graphene writing exclusively onto the surface of the carbon source where irradiation takes place. This process is bound to certain limitations in regard to applications where graphene must be transferred onto another substrate via complicated, time consuming processes, which affect graphene quality and properties.²⁸ In general, the transfer process employs many labor-intensive steps and uses chemicals that induce defects and contamination of the transferred graphene. The graphene film prepared by the disclosed method, however, does not need to be manually transferred, as it is directly forwarded by the propelling gas (produced by the violent target source decomposition) towards the host substrate surface. The process of the current disclosure ensures homogeneous coverage of the substrate by a graphene with a three-dimensional texture.

Laser-induced growth methods of graphene and GRMs have appeared in recent years via irradiation of synthetic polymers, cloth, paper, potato skins, coconut shells, cork, and activated carbon.²⁴ There are, however, particular shortcomings associated to those methods which limit the versatility of manipulation and use and restrain scalability to industrial level production. These shortcomings are currently recognized as the main causes of limited viable applications. Shortcomings associated with the use of industrial-type lasers are briefly described below.

Typically, mid-IR lasers are used operating at 10.6 μm (CO₂ laser). This laser light wavelength is beyond the current technical capabilities for being delivered by optical fibers, which are frequently used to safely deliver laser beams. Therefore, the industrial use of such laser sources to large area graphene growth poses technical concerns and safety risks. The use of chambers for controlling the atmosphere (vacuum, inert or reducing gasses) during laser-assisted decomposition is a major weakness of the CO₂ lasers. Typical silica windows are opaque to the 10.6 μm radiation; hence, special ZnSe windows are needed. The size of the window prepared by this expensive material is limited, hence precluding irradiation to areas larger than few tens of cm².²⁴

The methods of the prior art,²⁴ provide graphene synthesis exclusively onto the surface of the irradiated material. The graphene is formed as a layer with thickness of several tens of microns, depending on the penetration depth of the laser light and fluence of the irradiation. The graphene film is supported by the body of the precursor material that has remained unaffected by the radiation. For particular uses, the formed graphene layers may be mechanically transferred via a number of steps to another substrate, accompanied with a number of shortcomings that deteriorate graphene properties, as discussed in previously. In particular, transfer methods of prior art—where graphene grows by lasers on the surface of the precursor onto the surface of the desired device part, e.g. an electrode—require complex processes which involve several steps, namely, transfer of graphene from the substrate to the electrode surface, by steps such as mold-casting and peeling off the substrate layer.

A method based on the use of two different lasers,¹⁷ which has been reported for the sequential graphene growth on Kapton foils and subsequent transfer onto another substrate, does not alleviate major problems encounter by the current disclosure, which resolves the problem of simultaneous graphene growth and transfer from any carbon source to any substrate using a single lase pulse at ambient conditions. The prior art,¹⁷ is based on and demonstrated for only on a certain material (polyimide foil) in addition to being bound to the use of two laser sources and limited by uniformity issues, as the second laser source is used to transfer by conventional LIFT process the already formed graphene.

### Solution to Problem

The current disclosure provides a method to use laser beams (or laser pulse) to produce and simultaneously transfer (LEST) high-quality graphene and graphene-based nanohybrids onto a desired preselected substrate, in a single step. Different lasers have been employed to achieve LEST graphene and graphene-based hybrids, with a wavelength varying in the range 0.9 nm up to 3000 nm. Typical high-power, industrial type lasers comprise diode laser (980 nm), Nd-YAG (1064 nm), Yb-fiber laser (1070 nm), Er-fiber laser (1550 nm) Ho-YAG (2100 nm) or other laser systems operating in the above-defined wavelength range. Laser pulse duration may be selected in the ms (10⁻³ s) to fs (10⁻¹⁵ s) range, preferably chosen at the longer pulse width of this range.

In a specific embodiment, the disclosed method makes use of an industrial type laser, widely available in marking/welding processes, operating at mid-IR wavelengths, Nd-YAG (1064 nm), resulting in the advantageous effect of high yield rate production of high-quality turbostratic graphene with enhanced specific surface area and very low sheet resistance.

Inadequate global production and material quality are key issues. Defining graphene quality has been a matter of controversy, especially as regards commercially available graphene materials.⁷ To provide a reliable characterization analysis for the graphene and graphene-based products of the current disclosure, we follow a recently announced international standard, i.e. ISO/TS 21356-1:2021 Nanotechnologies—Structural characterization of graphene—Part 1: Graphene from powders and dispersions.

Using the process of the current disclosure we have been able to achieve high-quality turbostratic few-layer graphene—a more conductive structure in relation to the typical Bernal-stacked few-layer graphene—by a single lase shot employing various classes of materials as carbon source. The turbostratic nature has been unequivocally demonstrated by spectroscopic and electron microscopy techniques. It is important to note that a turbostratic structure of graphene is obtained by the method of the current disclosure both in the case where the target irradiated by the laser is a single carbon source, as well as in the case where the target comprises a carbon source and a precursor; in this latter case the final transferred product is few-layer turbostratic graphene mixed with inorganic nanoparticles, forming a graphene-based nanohybrid, as disclosed by specific embodiments.

Using the process of the current disclosure, we have produced high-quality graphene from various sources such as polymers, organic matter, biomass-derived products and their combinations. Elemental carbon materials mixed with proper compounds to offer propelling gasses can also be used. When additional precursor(s) material is added to the target carbon source, then nanohybrid materials comprising turbostratic graphene and various types of nanoparticles are prepared. Whereas such graphene-based nanohybrids are currently prepared employing a wide variety of ways including chemical and physical methods, no similar attempt has been reported where their preparation on selected substrates takes place by a solvent-free, single-step growth and transfer, by laser irradiation at ambient conditions.

The current invention is a versatile approach as it can provide a single-step, scalable production of graphene and graphene-based nanohybrids at ambient conditions, avoiding any wet-chemistry pre-treatment or post-processing. Embodiments of the disclosed invention provide information about how it can be applied to prepare the said functional materials on substrates such as electrodes for various applications. Examples provided comprise energy conversion and storage applications. The LEST process can further be utilized to deposit the above materials onto various textiles, fabrics, and flexible substrates, thus creating smart or electronic textiles with functionalities ranging from energy harvesting to sensors for IoT applications.

### Advantageous Effects of Invention

No attempt has been reported in the prior art aimed at achieving simultaneously the growth and forward/backward transfer of turbostratic graphene and graphene-based nanohybrids onto the desired substrate, by a single-step laser approach. The disclosed method differs from previous art where lasers are used to ablate graphite targets under ultrahigh vacuum conditions, as in those methods the carbon source is exclusively a graphite target and the ablated film on a substrate is mostly amorphous or nanocrystalline graphite.

The benefits of direct synthesis on any type of substrate and the feasibility of in situ patterning of the graphene film, together with the avoidance of using toxic chemicals, high-temperature, vacuum chambers and other strict conditions, render the current disclosure compatible with current industrial processes and, hence, an emerging rival of other physical/chemical methods.

A major desideratum in global graphene production is achieve a facile method to deposit graphene on a desired substrate. However, graphene synthesis methods based on high-temperature and chemical processes limit dramatically the type of the substrates to those that can withstand high temperature and harsh chemical environments. Hence, post-synthesis transfer of graphene to the desired substrate is pursued following a multi-step process. In the disclosed method the laser irradiation process does not affect the substrate, hence various types of substrates, sensitive to temperature and chemicals, can be utilized.

Embodiments of the current disclosure demonstrate the feasibility of such a process, operating at ambient conditions (in the open environment), by producing and transferring turbostratic graphene and graphene/-based nanohybrids on any type of substrate. The high-quality of the obtained products is showcased, but not limited, by two examples related to energy conversion/storage applications.

The accompanying drawings, which are incorporated herein, and constitute part of this specification, illustrate exemplary embodiments of the invention. Together with the description given above and the detailed description given below, serve to explain the features of the invention.

### DESCRIPTION OF FIGURES

FIG. 1 is a schematic drawing of the irradiation geometry of an incident laser beam (LB). Scheme (1A) illustrates an example of a forward LEST process. The target source is a semi-transparent film (in regard to the incident laser wavelength) comprising the carbon source (CS). Graphene is deposited at the acceptor substrate (AS). Scheme (1B) illustrates an example where a carbon source layer which has been pre-deposited on the rear side of a transparent substrate (TS). Graphene is deposited at the acceptor substrate (AS). Scheme (1C) illustrates an example of a backward LEST process where the laser beam passes through the TS unhampered and reaches the CS film. Graphene material is collected at the side of the TS facing the CS. The TS has the dual role also of the AS.

FIG. 2 illustrates optical images of LEST graphene deposited on four typical substrates.

FIG. 3 illustrates field-emission scanning electron microscopy (FE-SEM) images of (a) graphene and (b) graphene/SiOₓ nanohybrids deposited on polydimethylsiloxane (PDMS). FE-SEM images of (c) graphene and (d) graphene/SiOₓ nanohybrids, deposited on carbon fiber paper.

FIG. 4 illustrates high-resolution transmission electron microscopy HR-TEM images, (a) and (b) of graphene structures. (c) Low magnification, and (d) HR-TEM images of graphene/SiOₓ nanohybrids.

FIG. 5 illustrates HR-TEM image of the graphene structures obtained and corresponding fast Fourier transforms (FFTs) of the areas indicated by green squares. The local FFTs exhibit graphene interlayer spacing d₀₀₂ in the range 0.344-0.364 nm.

FIG. 6 illustrates Raman spectra of: (a) graphene grown on front and back side of the carbon source foil in the course of a single irradiation step, according to the method of Scheme (1A). (b) Graphene and graphene/SiOₓ nanohybrids grown by laser-induced forward transfer according to the method of Scheme 1(A). (c) Lorentzian line fitting of a Raman spectrum; the inset shows in magnification the spectral area of the turbostratic peaks. (d) Sheet resistance, Rₛ, of graphene and graphene/SiOₓ transferred onto glass and PDMS substrates.

FIG. 7 illustrates the analysis of X-ray photoelectron (XP) spectra of (a) C1s peak from the carbon source and (b) Si2p peak from the precursor material. (c) Survey scans of the laser-assisted produced graphene and graphene/SiOₓ materials. Analysis of XP spectra of the C1s peak of (d) graphene and (e) graphene/SiOₓ. Analysis of the Si2p component of the graphene/SiOₓ nanohybrid.

FIG. 8 illustrates (a) a schematic of the structure of the single-electrode triboelectric nanogenerator (TENG) device. (b), (c) Open circuit voltage, V_{OC}, generated during contact and separation of PDMS with human skin with graphene and graphene-SiOₓ nanohybrid as electrode, respectively. (d), (e) Output voltage and short circuit current (I_{SC}) generated upon different external load resistors. (f) Output power density of the TENG devices as a function of the load resistance.

FIG. 9 illustrates cyclic voltammetry (CV) curves at different scan rates for the supercapacitors prepared by four different electrodes of variable loading. Neat graphene electrodes: (a) KTa, (b) KTb. Graphene/SiOₓ electrodes: (c) KFa, (d) KFb. Sample notation is as follows. KTa: one lasing pass on only one surface of the carbon paper. KTb: one lasing pass for each surface of the carbon paper. KFa: two lasing passes on only one surface. KFb: two lasing passes on both surfaces.

FIG. 10 illustrates (a) Galvanostatic charge-discharge curves for graphene as obtained by (a) a single LEST process (KFₐ) and (b) LEST processes repeated two times (KF_{b}). (b) Electrode capacitance retention versus the scan rate used in cyclic voltammetry and versus discharge current density used in galvanostatic charge discharge curves.

FIG. 11 illustrates representative Raman spectra (part A) and SEM images (part B) of additional classes of carbon source materials, i.e. (a) phenol-based thermosetting resins, e.g. mixtures of resorcinol and furfural, and (b) biomass, e.g. homogenates of Corinthian raisins, Vitis vinifera L., var. Apyrena.

FIG. 12 illustrates SEM images of backward LEST turbostratic graphene prepared by the scheme 2 of FIG. 1 using polyimide as the carbon source and a silica plate as the T-AS substrate.

### DESCRIPTION OF EMBODIMENTS

The present invention expands the capabilities of prior art in relation to high-quality synthesis of graphene and graphene nanohybrids and the simultaneous transfer (forward or backward) of the said products onto various substrates. In some aspect, the process enables the one step integration of graphene-based materials into certain devices via a laser-based additive manufacturing manner or a 3D printing process.

In the prior art, methods using lasers to convert carbon sources to graphene are able to prepare or “write” graphene structures only onto the surface of the target material, typically a carbon source. Whereas, the current invention demonstrates that growth and forward or backward transfer onto the desired surface can take place by a single step, one pulse, process at ambient conditions for various classes of target materials comprising of carbon sources and other precursors.

The carbon source can be a compound such as an organic compound, a polymer, or can be selected from various types of biomass-derived materials. Although each individual material used as the carbon source requires certain irradiation conditions to achieve transformation to high-quality few-layer graphene, there are no certain structure requirements of the selected precursor as in previous art using laser-based graphene synthesis methods. The success of the current disclosure, as regards the laser-assisted transformation of carbon sources (excluding the case where the carbon source is simply elemental carbon) can be assessed by the percentage of carbon element in the final decomposed product. The transformation of the carbon source to graphene structures achieved by the disclosed LEST method is higher than that reported in the prior art, because the carbon element percentage in the decomposed product can be at least 95%, using a single lase irradiation.

In particular embodiments of the current disclosure it is revealed that given the specific bonding characteristics of the chemical groups comprising the structure of the carbon source, the laser fluence has been optimized towards providing the proper thermal content and heating rate to achieve best decomposition result leading to sp² carbon hybridization within the graphene layer, while at the same time the produced few layer structures are disposed in a turbostratic arrangement.

According to disclosed embodiments, the carbon source should exhibit proper optical absorption at the selected laser wavelength, i.e. the carbon source layer thickness should preferably be comparable to the penetration depth of the laser radiation. Alternatively, the carbon source optical properties can be modified to match the above condition by heat or other pre-treatment, including heat, laser processing, or blending with small concentration of substances offering absorption sites; hence fulfilling the desired optical absorption requirements.

The structure of carbon source should contain chemical groups capable of providing propelling gases as a result of the laser-assisted violent decomposition, which enable the forward/backward transfer of the graphene fragments onto the desired substrate.

Although vacuum or inter gas or reducing gas atmosphere can be used to protect the transformation of the carbon source to high-quality graphene from oxidation due to atmospheric oxygen, as is typically followed in the prior art, the disclosed process performs exceptionally well at ambient atmosphere conditions (pressure, humidity, oxygen content).

The spacing between target material and substrate can be selected in a variable range. The lowest can be when target material and substrate are placed in contact, while their distance can extend up to several cm, depending upon the type of the target material, the sensitivity of the substrate material to laser irradiation, and the graphene film thickness needed to be achieved. Typical graphene film thicknesses fall within the range of few nanometers up to few tens of micrometers, depending on the pursued application. Repetitive deposition using the LEST process has been used to prepare graphene films with thickness higher than few tens of microns.

Apart from the carbon source, the target material may include at least another precursor material, selected from various classes of compounds, such as metal salts, organometallic compounds, metals, metal oxides, metal sulfides, metal carbides, and combinations thereof. The precursor material is sensitive either to the laser radiation (due to direct absorption) and/or to the heat generated by the carbon source temperature rise and decomposition. Hence, the precursor material decomposes simultaneous with the carbon source by the laser beam (laser pulse), to provide a hybrid nanostructure material, for example graphene decorated with inorganic nanoparticles; the latter being members of the materials families mentioned above. Precursors materials exhibit typically lower decomposition temperatures (lower than ca. 1500° C.) in comparison to the temperature rise achieved by the laser for the carbon source decomposition (typically >1500° C.). A major advantage of this dry process, is the lack of chemical wastes and the excellent dispersion of the nanoparticles onto the graphene surface.

The disclosed method does not require the use of controlled atmosphere i.e. a protective chamber to apply vacuum, inert or reducing gasses, as the prior art necessitates to graphitize certain carbon sources. The lack of need for performing the irradiation into a chamber with strict size conditions, has enabled to direct the laser beam along large areas on the target surface, using for example a galvo-mirror system. These conditions render the current invention industrially relevant and easily adaptable to current technological platforms, whereas methods in prior art require the use of special chambers with limited size windows for the laser beam entrance, hence limiting the scalability potential and increasing the production cost.

In another embodiment, we have applied the disclosed method of laser-assisted growth and simultaneous transfer of graphene and graphene-based nanohybrids on a selected substrate, has been integrated for operation in a roll-to-roll (R2R) process for applications that require large scale graphene deposition onto selected flexible surfaces, such as textiles, fabrics and other flexible materials.

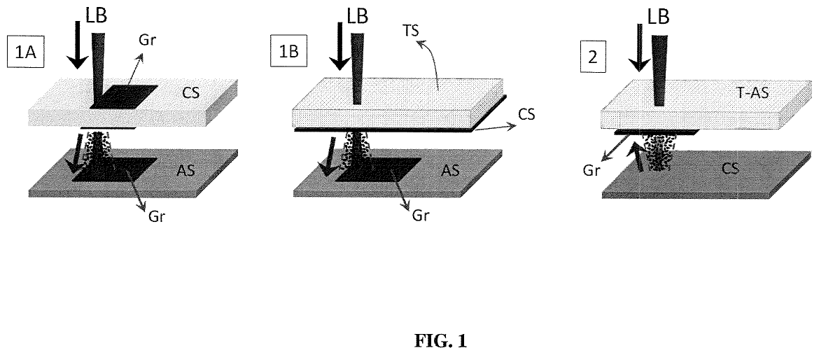

According to the disclosed embodiments, various alternatives of the irradiation geometry may be used in the LEST graphene synthesis. FIG. 1 illustrates typical examples of irradiation geometries which have been applied successfully in the current disclosure. Additional geometries emerging as combinations of these basic three irradiation modes or slight alternations of them have also been employed.

The Scheme (1A) in FIG. 1 illustrates an example of a forward LEST process. The target material lies between the incident laser beam and the acceptor substrate (AS). A semi-transparent film, in regard to the incident laser wavelength, is used as the target material. The penetration depth of the laser radiation is comparable to the target material thickness; this allows the laser beam to penetrate through the target material. Selecting a carbon source as the target material, the deposited film consists of few-layer turbostratic graphene. Selecting the target material as a carbon source with a combination of precursor materials discussed above, few-layer turbostratic graphene-based nanohybrids (graphene decorated by nanoparticles/nanostructures) are obtained. Examples presented in the disclosed embodiments use a foil of polyimide (PI, Kapton™), a film of thermosetting phenolic resins and a biomass-derived product as the carbon sources. Whereas an example is presented where a Kapton foil is sued as the carbon source and polydimethylsiloxane (PDMS) is used as the precursor which transforms to SiOₓ nanoparticles upon decomposition; the latter decorate the surface of turbostratic graphene layers.

The Scheme (1B) in FIG. 1 illustrates another example of a forward LEST process. A carbon source material can be pre-deposited on the rear (bottom) side of a transparent substrate (TS). The TS can be any glass composition or polymeric foil or other transparent material that does not absorb significantly the laser radiation. The carbon source may be deposited via evaporation, sputtering, spraying, spin coating, doctor blade, sol-gel, electrodeposition, and related techniques. The target material lies between the incident laser beam and the acceptor substrate (AS). Laser beam may pass with no particular losses through the TS body leaving the TS intact. Laser fluence loss during beam penetration through the TS may be less than 10% or better may be less than 5%. Examples presented in the disclosed embodiments use a phenolic resin and a biomass-derived material as target sources deposited on transparent glass substrates.

The Scheme (2) in FIG. 1, illustrates an example of a backward LEST process. The transparent acceptor substrate (T-AS) must be transparent to the laser wavelength, and lies between the incident laser beam and the target material. The laser beam penetrates through the transparent acceptor substrate, reaching the CS material, inducing the decomposition of the latter. Fluence loss during beam penetration through the T-AS may be less than 10% or better may be less than 5% to avoid partial damage of the T-AS. In an example presented in the disclosed embodiments a polyimide has been used as the carbon source and a fused silica glass has been used as the T-AS.

The process of the current disclosure has been optimized such as one lase pulse is capable of transforming the target materials to high quality turbostratic graphene or graphene-based nanohybrid. Large area graphene deposition requires scanning of the laser beam along a number of loci of points onto the target material. In a particular embodiment, the laser beam has been scanned in a motif where partial overlap between the various irradiated spots takes place. The overlap results in sequential/additional irradiation of already formed turbostratic graphene, which does not deteriorate the structure and the quality of the latter.

### Examples

Various types of target materials were examined, comprising members of typical classes of carbon sources and precursors. All target materials have shown excellent transformation to turbostratic graphene and graphene-based hybrids. Representative examples of target materials provided here include: (i) A commercial polymer, i.e. polyimide (PI, Kapton™, RS Components product #171-1615) as the CS in the form of foil, which will be called hereafter as Kapton foil. (ii) A CS and a precursor, comprising, for example, of a Kapton foil as the CS and a silicone adhesive film (PDMS) which deposited on one side of the Kapton foil; PDMS acts as the precursor whose decomposition provided for silicon oxide nanoparticles. This will be called hereafter as Kapton tape. (iii) A biomass-derived product. The biomass source of the present study was dried Black Corinthian Currants (Corinthian raisins, Vitis vinifera L., var. Apyrena), obtained from the local retail market. The raisins were soaked in water and were mechanically homogenized. (iv) A phenol-based thermosetting resin, i.e. a mixture of resorcinol and furfural.

The present invention demonstrates that a single lase (single pulse) irradiation at ambient atmosphere, in the frame of Schemes (1A), (1B), and (2) in FIG. 1, is sufficient to convert the target material into high-quality turbostratic graphene (carbon source) and turbostratic graphene/nanoparticles hybrids (carbon source plus precursor) which renders the process simple and effective. The overlap of the irradiated spots does not deteriorate graphene quality.

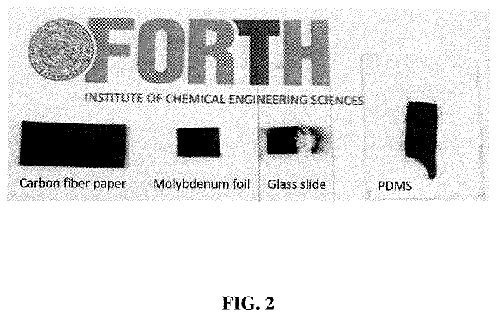

To demonstrate the versatility of the disclosed approach, all three different irradiation Schemes described in FIG. 1 have been employed to develop graphene-based films on a diverse set of substrates including soft materials, glass, metals, ceramics, cloth, and so on. Typical substrates selected from these categories comprise of the following ones: polydimethylsiloxane (PDMS), polyethylene terephthalate (PET), molybdenum foil, carbon fiber paper, glass and so on. FIG. 2 depicts optical images of laser-assisted grown turbostratic graphene forward transferred on various substrates.

The feasibility of embodiments of the current disclosure depicted in Schemes (1A) in FIG. 1 has been verified using a Kapton foil (ca. 70 μm thick) as the carbon source and a Kapton tape composed of a Kapton layer as the carbon source and a silicone-based adhesive film (total thickness of ca. 65 μm thick) used as the precursor material. The Kapton foil and tape precursors were irradiated using overlapping pulses (50% overlap area) with a large spot size of about 2.0 mm in diameter. This is an indicative spot size, whereas much larger sizes have also been employed with the requirement of maintaining the fluence in the range of optimum conditions for best turbostratic graphene quality.

Various fluences ranging from 10 to 200 J cm² were employed to select the optimum conditions for the transformation of the target materials to high-quality turbostratic graphene and graphene/SiOₓ nanohybrids, respectively. The Kapton foil and Kapton tape were placed in certain distances from the acceptor substrate to ensure both a homogeneous coverage and achieve at the same time good adhesion of the graphene-based film on the substrate.

The irradiated volume of the target material experiences violent decomposition under the action of the laser pulse. Previous irradiation studies of Kapton using ultra-violet (UV) lasers were focused on providing conductive paths on the surface of the Kapton foil. These studies have shown that Kapton decomposition results in a rich variety of produced gasses. Mass spectroscopy has revealed the presence of species such as C₂H₂, HCN, CO, CO₂, C₄H₂, and C₆H₂.²⁹ The current disclosure exploits the violent outflow of these gasses, which can propel the carbon fragments towards the acceptor substrate according to the Schemes shown in FIG. 1. Laser parameters have been optimized so as the carbon fragments deposited onto the acceptor substrate are structurally reorganized to high-quality turbostratic graphene structures.

To proceed to a reliable characterization of the graphene-based materials a number of techniques have been used. In particular, electron microscopy and Raman scattering and the data analysis of these techniques were conducted using the international standard, i.e. ISO/TS 21356-1:2021 Nanotechnologies—Structural characterization of graphene—Part 1: Graphene from powders and dispersions.

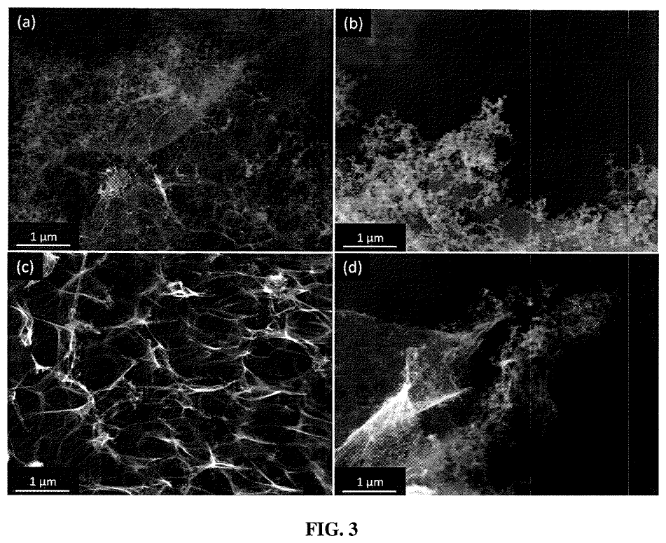

The microstructure details of the deposited graphene films were observed by field-emission scanning electron microscopy (FE-SEM). Examples for graphene and graphene/SiOₓ nanohybrids deposited on two types of substrates, i.e. PDMS and carbon fiber paper, are illustrated in FIG. 3. The images demonstrate a highly porous structure, which originates from the violent decomposition of the carbon source causing a rapid outgassing of the above-said gasses (see previous paragraph). In the case of carbon source/precursor (PI/silicone adhesive) decomposition, the graphene structures appear decorated with SiOₓ nanoparticles, FIGS. 3(b), (d). The latter arise from the disintegration of the silicone-based precursor into SiOₓ nanoparticles.

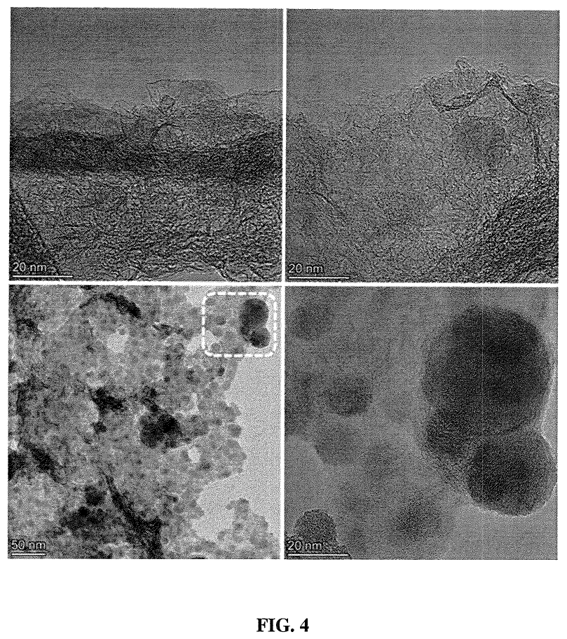

A more detailed view of the morphology at the nanoscale is provided by the high-resolution transmission electron microscopy (HR-TEM) images depicted in FIG. 4. Images 4(a) and 4(b) demonstrate the formation of graphene layers, showing nearly-free graphene layers at the edges of the structures. A deeper inspection reveals that few-layer stripes—comprising 2 to 4 graphene layers—percolate through the structure of the material. These observations point towards the growth of non-compact structures lending unequivocal support to the graphene-like character of the transferred material.

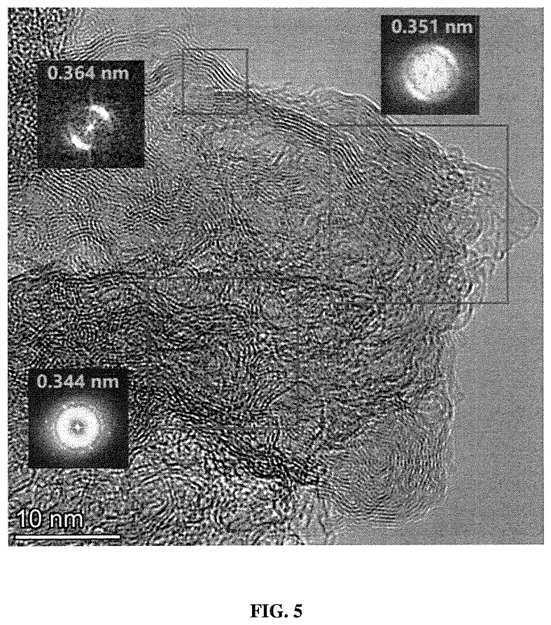

The average interlayer spacing, d₀₀₂, between the graphene layers has been estimated by analyzing those images using local area fast Fourier transforms. The analysis has shown d₀₀₂ values in the range 0.341-0.364 nm; a typical paradigm is shown in FIG. 5. Selected area electron diffraction (SAED) analysis shows that the interlayer spacing is far larger than that of the Bernal stacking (0.334 nm), signifying the formation of a highly desired structure of few-layer graphene, known as turbostratic graphene. This is the first demonstration of turbostratic graphene growth based on laser-assisted synthesis.

The demonstration of the laser-assisted synthesis of turbostratic graphene is a unique merit of the current disclosure. For reasons described in previous paragraphs (see “Technical Problem”, p. 5), turbostratic graphene is considered to exhibit electronic properties superior to those of few-layer Bernal-stacked graphene. Few-layer graphene with Bernal stacking is the main product of all previous reports of the prior art obtained by laser irradiation.

As illustrated by HR-TEM in FIG. 4(c), a large density of SiOₓ nanoparticles decorating the turbostratic graphene layers are formed when a carbon source (Kapton) and a precursor material (silicone adhesive layer) comprise the target material; irradiation takes place according to Scheme 1(A). The particle size of SiOₓ nanoparticles lies in the range 15-20 nm. Image 4(d) shows a magnification of the upper right part of image 4(c) marked in the rectangle. This image demonstrates that graphene layers may be disposed wraparound the nanoparticles forming an interacting phase of the nanohybrid system. The graphene scaffold of the nanohybrid does not present structural differences in comparison to the neat graphene obtained by the Kapton foil (neat PI) irradiation; they are both of turbostratic structure.

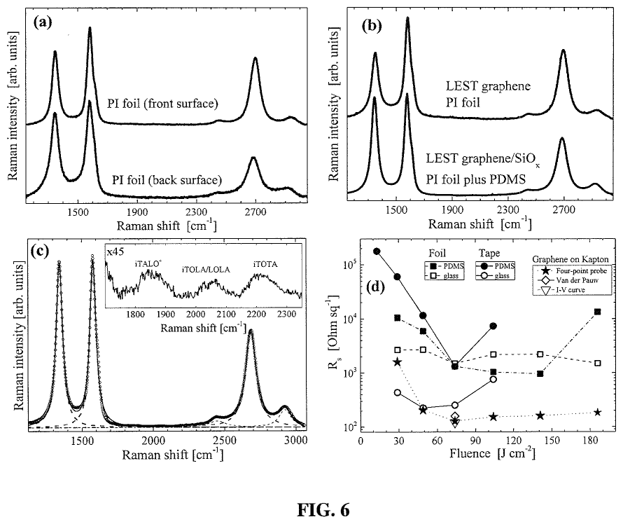

Raman spectra of graphene grown on the front and back surface of the Kapton foil are shown in FIG. 6(a). These spectra reveal better graphene quality (turbostratic) in relation to the corresponding spectra of the prior art for graphene films (non-turbostratic) grown on the target surface by laser irradiation. However, apart from the turbostratic nature of graphene, the novelty of the current disclosure relates to the simultaneous transfer of the graphene film (by the LEST mechanism) onto an acceptor substrate according to the Scheme (1A). The Raman spectra of LEST graphene are presented in FIG. 6(b). In all these cases the spectra reveal excellent transformation of the carbon source structure to few-layer graphene obeying mostly sp² carbon hybridization.

Additional spectroscopic evidence for the turbostratic structure of few-layer graphene arises from the symmetric shape and single-Lorentzian character of the 2D band shown in FIGS. 6(a),(b). This finding provides additional support to the structure of the expanded d₀₀₂ interlayer spacing observed by HR-TEM, shown in FIG. 5. Clear proof about the turbostratic nature of the graphene-like structures produced by laser-assisted decomposition of the carbon source is provided in FIG. 6(c), inset. The turbostratic arrangement originates from rotationally faulted layers and/or layers with expanded interlayer distance. The weak Raman bands which appear in the energy range between the G and 2D peaks, 1800-2300 cm⁻¹, demonstrate the formation of turbostratic graphene.³⁰

The LEST turbostratic graphene films exhibit excellent sheet resistance features in relation to other graphene films and powders, e.g. prepared by laser radiation, reduction of graphene oxide, and CVD-grown graphene which has been subsequently transferred onto another substrate. The enhanced sp²/sp³ ratio of carbon atoms obtained by the LEST method is in accordance with the lowest sheet resistance, Rₛ, as shown in FIG. 6(d). The figure displays the sheet resistance values of the graphene-like films prepared by the methods of Scheme (1A) using Kapton as carbon source in one example, while using Kapton as carbon source and PDMS as the precursor. The graphene and graphene/SiOₓ hybrid were deposited on two different substrates, i.e. glass and PDMS. The fluence dependence of Rₛ for graphene grown on the Kapton surface is also shown for comparison. The curve shows an appreciable decrease of Rₛ, while increasing fluence, reaching the value of 129 Ωsq⁻¹ at 74 J cm⁻², followed by a mildly increasing trend for higher fluences. Either sharper or less pronounced, the curves exhibit minima in the sheet resistance curves against fluence.

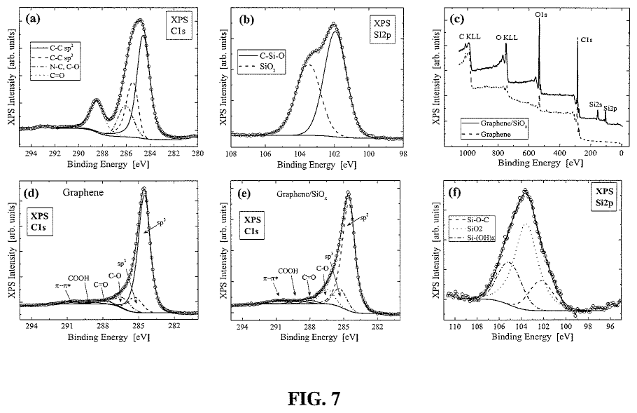

Detailed analysis of the chemical bonding of the graphene films has been carried out by X-ray photoelectron spectroscopy (XPS). The C1s XPS peak of the carbon precursor, shown in FIG. 7(a), is analyzed into four components assigned to C—C sp², C—C sp³, C—N/C—O and C═O bonds. The Si2p XPS peak of the precursor material (silicone adhesive, i.e. PDMS), FIG. 7(b), is analyzed into two components assigned to C—Si—O,³¹ and to SiO₂ species.³²

Survey spectra of the LEST products, i.e. graphene and graphene/SiOₓ hybrids, are shown in FIG. 7(c). The almost complete absence of nitrogen (<0.5±0.1 at. %) demonstrates a very efficient laser-induced decomposition of the nitrogen-containing carbon source (PI) to elemental sp² carbon. Each of the deconvoluted C₁s peaks illustrated in FIGS. 7(d) and 7(e), consists of six components. The relative fractions of the various species are similar for the C₁s peak of the graphene and graphene/SiOₓ materials. A very high degree of sp² carbon atoms emerges, in relation to the sp³ bonded ones, after decomposition. The ratio sp²/sp³ is of ca. 8 for graphene and 7 for graphene/SiOₓ hybrids, respectively. These values are much higher than values reported in the prior art for laser-assisted produced graphene.³³

The deconvolution of the Si2p XPS peak, of the graphene/SiOₓ films, is presented in FIG. 7(f), which shows that three components constitute this composite peak. The peak at 103.5 eV has unequivocally been assigned to stoichiometric silica, SiO₂, where Si obeys the +4 oxidation state.³² The peak at 102.2 eV corresponds to Si oxidation state +3 and can be associated with Si—C bonds in tetrahedral species of the type O₃—Si—C.¹⁸ The peak at the higher BE is related to Si(OH)ₓ species,³⁴ with x estimated to be in the range 1.5<x≤2 according to current data. Combining the results of Si2p analysis with the total Si at. % we estimate that ˜25% of the O atoms are bonded to Si. As a result, almost 2% of O atoms bond to C atoms, yielding an atomic ratio of C/O≈30 for the graphene/SiOₓ film (carbon source +precursor), which is the same with the C/O ratio of the graphene film (carbon source). The C/O ratios of the current disclosure are the highest reported values C/O values obtained by various methods of graphene synthesis via laser decomposition of organic matter.

Due to advantageous effects of the graphene-based materials prepared by the disclosed embodiments, exploitation of their unique behavior pertains to a wide variety of applications including, but not limited to sensors, membranes for air purification/gas separation/desalination, coatings for protection against corrosion, high-temperature, flame-retardant surfaces, lightweight composites, photocatalysis, water splitting, energy conversion and storage devices and combinations thereof. For example, the direct growth and simultaneous transfer of graphene on any type of substrate enables rapid, chemicals-free, large-scale and cost-efficient fabrication of electrodes. We demonstrate in some embodiments how the high-quality turbostratic graphene obtained by the current disclosure can be exploited in two case examples in energy conversion and storage. These examples refer to power sources; in particular, flexible triboelectric nanogenerators (TENGs) and electric double layer capacitors (EDLCs) or supercapacitors.

A specific example of the implementation of the LEST method is as follows. A single-electrode TENG device architecture is implemented by the method shown in Scheme (1A) of the current disclosure. Graphene and graphene/SiOₓ hybrids were deposited by LEST on a flexible substrate, i.e. PDMS. Graphene and graphene/SiOₓ hybrids act as electrodes, while the PDMS plays the role of the tribo-material. A fairly low sheet resistance of the graphene film and its ability to withstand several cycles of contact-and-separation operation are key factors towards replacing the precious metals (Au, Pt) deposited on the back side of the contact material used in prior art. To demonstrate the application potential of the flexible, wearable TENG devices fabricated by the current method, the single-electrode construction adopted here employs PDMS and human skin as active tribo-materials.

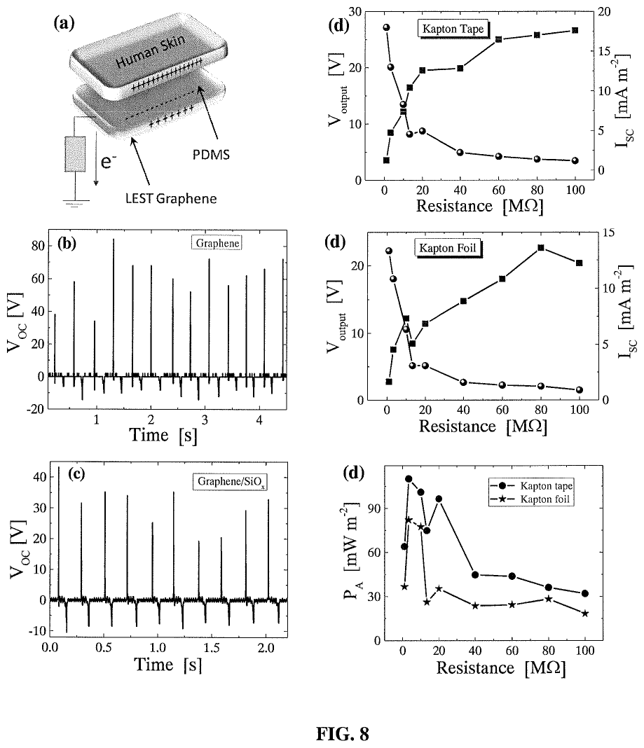

The schematic design of the TENG devices are shown in FIG. 8(a). The active area of the device is 1×2 cm². The disclosed method is much simpler, faster and less costly than processes employed in the prior art, which necessitate more steps for the electrode preparation, namely, transfer of graphene from Kapton onto PDMS, by mold-casting the latter on the graphitized side of Kapton and peeling off the Kapton foil.³⁵

Open circuit voltage (V_{OC}) peaks generated by tactile motion (soft finger tapping) imposed on the PDMS side for the neat graphene electrode and the electrode of the graphene/SiOₓ nanohybrid, are displayed in FIGS. 8(b) and 8(c), respectively. The normal force applied in this way is typically in the range 0.2-1.0 N. The comparison reveals that the peak-to-peak average V_{OC} induced by the PDMS/human skin-based TENG lies within the range of 50-60 V for the device employing neat graphene as the electrode, whereas it almost halves, ˜30 V, when the nanohybrid graphene/SiOₓ is used as the electrode material.

The irregularity of the peak maxima reflects the fact that the signal has not been measured using a constant force generated by a vibrating motorized machine, but by means of finger tapping, as mentioned above. The tactile motion used in the particular embodiment of the current disclosure simulates more realistically vibrational energy generated by the human body, which is harvested and converted into electrical energy by the TENG device.

The said device was subjected to long-term testing, reaching more than 5,000 cycles over a period of few months, showing minor decrease of the V_{OC}. Despite that the TENG devices were not treated under protective conditions, they exhibited high stability and integrity being able to light at least 20 green LEDs. This result demonstrates that graphene and graphene/SiOₓ films prepared by the methods of the current disclosure are able to overcome issues, such as adhesion and atmospheric effects, which is a main concern in the case of electrodes prepared by the methods of the prior art.

The output power of the TENG device upon external loading has been determined by the output voltage, Vₒᵤₜₚᵤₜ and short circuit current, I_{SC}, as shown in FIGS. 8(d) and 8(e). The graphene/SiOₓ nanohybrid exhibits better response in comparison to the neat graphene device This is quantitatively reflected in the generated power per unit area, Pₒᵤₜ^{A}, depicted in FIG. 8(f). The maximum Pₒᵤₜ^{A} is ˜82 and ˜110 mW m⁻² for the TENGs using graphene and graphene/SiOₓ, respectively. This is obtained when the load resistance is R^{L}≈3 MΩ for both TENG devices.

A remarkable outcome of the current disclosure is that graphene-based electrodes prepared by the LEST method, which enables their direct integration into a TENG device, has resulted in a device with the lowest impedance reported up to now in the prior art. Given the much higher impedance of other reported TENGs, the finding of the current invention is a significant advantage, considering that the reduction of the internal impedance is highly desirable in a number of devices requiring low impedance loads for many practical applications.

Flexible TENG devices disclosed by the current invention enable the implementation of high frequency TENG operation in wearable electronics. This has been practically limited in several applications in the prior art, due to physical constraints. The current design emerges as a promising solution towards realizing tactile sensors and other components embedded in electronic textiles.

Another specific example of the implementation of the disclosed LEST method for graphene preparation directly onto the surface of an electrode, pertains to the application in an energy storage device, such as a supercapacitor. The disclosed method has the advantageous effect of preparing binder-free electrodes for supercapacitors, based on the direct transfer of turbostratic graphene of the electrode substrate.

A carbon fiber paper (180 μm thick) served as the substrate onto which graphene and graphene/SiOₓ were deposited by LEST according to Scheme (1A). The deposited films differ in terms of weight according to the nature of the target. The combination of a carbon source and a precursor leads to higher deposition rate in relation to a carbon source target. In each case, a pair of identical electrodes were produced which were used to fabricate a series of symmetrical supercapacitors in the form of Swagelok type cells.

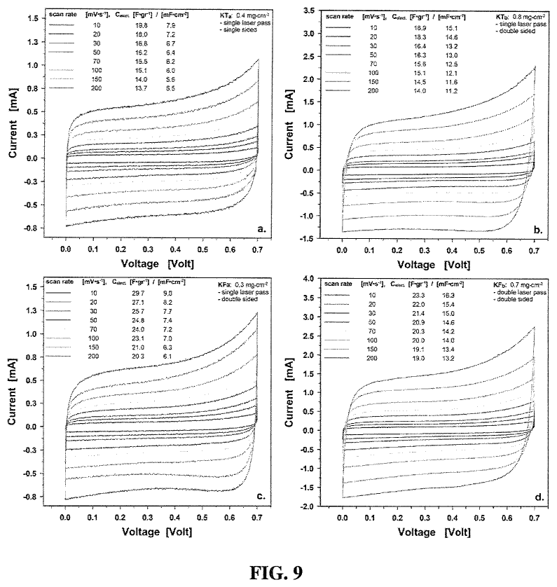

The cyclic voltammograms (CVs) at various scanning rates (10-200 mV s⁻¹) for the above four types of supercapacitors are depicted in FIGS. 9(a)-(d). In all cases, a quasi-rectangular CV shape is obtained and it is attributed to the electric double-layer capacitance (EDLC) nature of the graphene-based electrodes.

The symmetric and almost rectangular CV plots of the present embodiments, provide solid evidence of an ideal EDLC behavior. The gravimetric specific (C_{gr}) and areal (Cₐᵣ) capacitance of the electrodes were calculated using standard equations. Two laser passes were employed for the Kapton foil to achieve the same areal capacitance as that obtained by a single lase pass for the PI/silicone target. The graphene/SiOₓ electrodes yield an overall decreased gravimetric specific capacitance, in relation to the graphene electrodes, prepared using the same lasing procedure/steps.

Depending upon the scan rate, the calculated specific capacitance C_{gr} of graphene electrode is found to be 30 to 50% higher than that of the graphene/SiOₓ electrode, see FIGS. 9(b), (c). This reduction in the specific capacitance is attributed to the presence of SiOₓ particles.

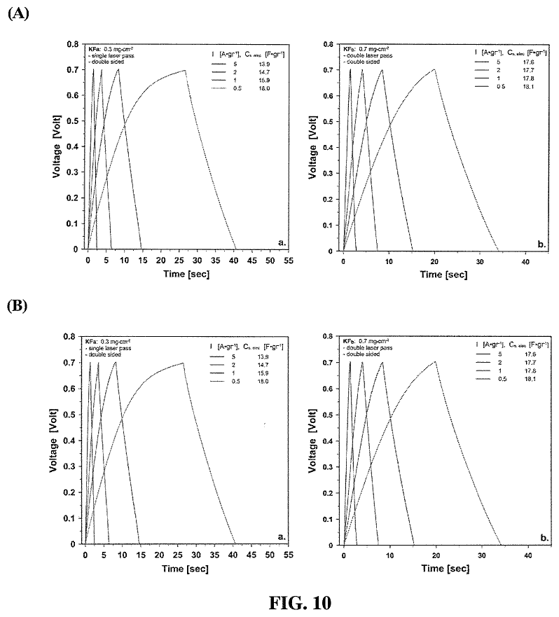

The capacitance of the graphene electrodes was also calculated by analyzing the galvanostatic charge-discharge (GCD) curves, shown in FIG. 10(a). The remarkable gravimetric capacitance retention (CR) of both graphene and graphene/SiOₓ electrodes (compared at similar lasing passes) is depicted in FIG. 10(b) as a function of the scan rate (v) and discharge current I_{d}. The KF_{b} electrode, exhibits outstanding capacitance retention vs I_{d} of about 97%.

Another example of the present disclosure pertains to the forward LEST graphene process for other types of carbon sources, such as thermosetting resins, e.g. resorcinol-furfural mixtures and biomass products derived from raisin homogenates. Graphene obtained from these classes of carbon sources has been prepared by the irradiation geometry of Scheme (1B) on glass substrates.

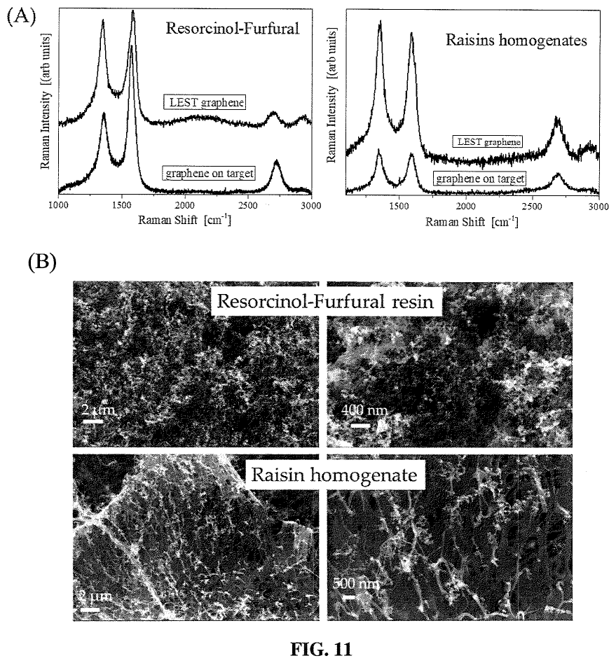

Representative Raman spectra are shown in FIG. 11(A), which reveal a high degree of conversion of the carbon source (raisin biomass) to graphene-like structures. Typical FE-SEM images obtained by those materials are illustrated in FIG. 11(B) at various magnifications. The graphene morphology has the same features and turbostratic structure as in the case of the carbon sources mentioned in previous examples. The spectroscopic and electron microscopy results demonstrate successful production of graphene with the LEST method. Electrochemical characterization of these materials resulted in ideal EDLC behavior.

Another example of the present disclosure pertains to the backward LEST graphene process implemented by the irradiation geometry of Scheme (2) shown in FIG. 1. For this particular example, polyimide has been used as the carbon sourced. A fused silica plate plays the role of the transparent-acceptor substrate (T-AS). Because the laser beam has to penetrate the T-AS to reach the target material, the laser fluence was properly optimized to account for the losses due to reflection caused by the T-AS surfaces. While absorption is of fused for the laser wavelength is minimal. In the current example, the losses of the fused silica substrate amount to ca. 10% of the incident beam fluence.

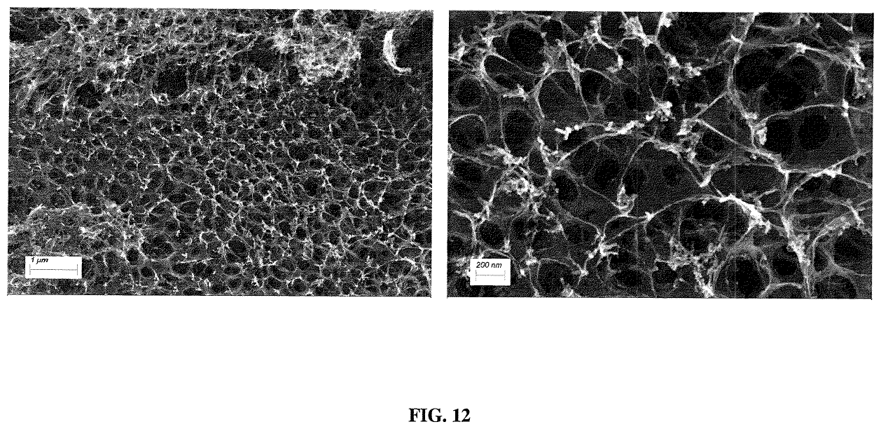

Characteristic FE-SEM images of the LEST graphene prepared by the method of Scheme (2) shown in FIG. 1, are illustrated in FIG. 12 at various magnifications. A porous-like graphene morphology is observed similar to those cases of the carbon sources mentioned in previous examples. Raman spectra of the LEST material has also demonstrated a high degree of conversion of the carbon source (polyimide) to graphene-like structures. These results provide solid evidence that the LEST method is capable for providing successful production of turbostratic graphene for the selected irradiation geometry.

Another example of the present disclosure pertains to the employment of the LEST method presented in Scheme (1A) shown in FIG. 1 to achieve a direct dispersion of turbostratic graphene structures, as they are produced by the laser-assisted decomposition of the target material, into the liquid matrix of a temperature-curable polymer, i.e. PDMS, to form a polymer/graphene nanocomposite. The major unique advantage of the solvent-free, direct dispersion of graphene into the partially cured polymer matrix is the avoidance of aggregation effects that intervene when graphene in powdered form is used in composites preparation. The graphene/PDMS composites prepared by the disclosed method attain excellent dispersibility of the graphene particles into the matrix leading to high conductivity (percolation limit) at low volume faction of turbostratic graphene into the polymer matrix.

### REFERENCES

1. ALLEN, M. J., TUNG, V. C. & KANER, R. B. Honeycomb Carbon: A Review of Graphene. Chemical Reviews. vol. 110, no. 1, January 2010, pages 132-145, ISSN 0009-2665
2. CASTRO NETO, A. H., GUINEA, F., PERES, N. M. R., NOVOSELOV, K. S. & GEIM, A. K. The Electronic Properties of Graphene. Reviews of Modern Physics, vol. 81, no. 1, January 2009, pages 109-162, ISSN 0034-6861
3. SCHWIERZ, F. Graphene Transistors. Nature Nanotechnology, vol. 5, no. 7, July 2010, pages 487-496, ISSN 1748-3387
4. FERRARI, A. C. et al. Science and Technology Roadmap for Graphene, Related Two-Dimensional Crystals, and Hybrid Systems. Nanoscale, vol. 7, no. 11, March 2015, pages 4598-4810, ISSN 2040-3364
5. SEGAL, M. Selling Graphene by the Ton. Nature Nanotechnology, vol. 4, no. 10, October 2009, pages 612-614, ISSN 1748-3387
6. ZURUTUZA, A. & MARINELLI, C. Challenges and Opportunities in Graphene Commercialization. Nature Nanotechnology, vol. 9, no. 10, October 2014, pages 730-734, ISSN 1748-3387
7. YANNOPOULOS, S. N., SIOKOU, A., NASIKAS, N. K., DRACOPOULOS, V., RAVANI, F. & PAPATHEODOROU, G. N. CO₂-Laser-Induced Growth of Epitaxial Graphene on 6H—SiC(0001). Advanced Functional Materials, vol. 22, no. 1, January 2012, pages 113-120, ISSN 1616301X
8. ANTONELOU, A., DRACOPOULOS, V. & YANNOPOULOS, S. N. Laser Processing of SiC: From Graphene-Coated SiC Particles to 3D Graphene Froths. Carbon, vol. 85, April 2015, pages 176-184, ISSN 00086223
9. LIN, J., PENG, Z., LIU, Y., RUIZ-ZEPEDA, F., YE, R., SAMUEL, E. L. G., YACAMAN, M. J., YAKOBSON, B. I. & TOUR, J. M. Laser-Induced Porous Graphene Films from Commercial Polymers. Nature Communications, vol. 5, no. 1, December 2014, page 5714, ISSN 2041-1723
10. CHYAN, Y., YE, R., LI, Y., SINGH, S. P., ARNUSCH, C. J. & TOUR, J. M. Laser-Induced Graphene by Multiple Lasing: Toward Electronics on Cloth, Paper, and Food. ACS Nano, vol. 12, no. 3, March 2018, pages 2176-2183, ISSN 1936-0851
11. ATHANASIOU, M., SAMARTZIS, N., SYGELLOU, L., DRACOPOULOS, V., IOANNIDES, T. & YANNOPOULOS, S. N. High-Quality Laser-Assisted Biomass-Based Turbostratic Graphene for High-Performance Supercapacitors. Carbon, vol. 172, February 2021, pages 750-761, ISSN 00086223
12. ANTONELOU, A., SYGELLOU, L., VRETTOS, K., GEORGAKILAS, V. & YANNOPOULOS, S. N. Efficient Defect Healing and Ultralow Sheet Resistance of Laser-Assisted Reduced Graphene Oxide at Ambient Conditions. Carbon, vol. 139, November 2018, pages 492-499, ISSN 00086223
13. SOKOLOV, D. A., SHEPPERD, K. R. & ORLANDO, T. M. Formation of Graphene Features from Direct Laser-Induced Reduction of Graphite Oxide. The Journal of Physical Chemistry Letters, vol. 1, no. 18, September 2010, pages 2633-2636, ISSN 1948-7185
14. ANTONELOU, A., BENEKOU, V., DRACOPOULOS, V., KOLLIA, M. & YANNOPOULOS, S. N. Laser-Induced Transformation of Graphitic Materials to Two-Dimensional Graphene-like Structures at Ambient Conditions. Nanotechnology, vol. 29, no. 38, September 2018, page 384001, ISSN 0957-4484
15. KUMAR, R., SINGH, R. K., SINGH, D. P., JOANNI, E., YADAV, R. M. & MOSHKALEV, S. A. Laser-Assisted Synthesis, Reduction and Micro-Patterning of Graphene: Recent Progress and Applications. Coordination Chemistry Reviews, vol. 342, July 2017, pages 34-79, ISSN 00108545
16. YE, R., JAMES, D. K. & TOUR, J. M. Laser-Induced Graphene: From Discovery to Translation. Advanced Materials, vol. 31, no. 1, January 2019, page 1803621, ISSN 09359648
17. ZHONG, H., ZHU, Z., LIN, J., CHEUNG, C. F., LU, V. L., YAN, F., CHAN, C.-Y. & LI, G. Reusable and Recyclable Graphene Masks with Outstanding Superhydrophobic and Photothermal Performances. ACS Nano, vol. 14, no. 5, May 2020, pages 6213-6221, ISSN 1936-0851
18. YANG, L., WANG, L., XING, M., LEI, J. & ZHANG, J. Silica Nanocrystal/Graphene Composite with Improved Photoelectric and Photocatalytic Performance. Applied Catalysis B: Environmental, vol. 180, January 2016, pages 106-112, ISSN 09263373
19. WATCHAROTONE, S., DIKING SASHA STANKOVICH, D. A., PINERY, R., JUNG, I., DOMMETT, G. H. B., EVMENENKO, G., WU, S. E., CHEN, S. F., LIU, C. P., NGUYEN, S. T. & RUOFF, R. S. Graphene-Silica Composite Thin Films as Transparent Conductors. Nano Letters, vol. 7, no. 7, June 2007, pages 1888-1892, ISSN 15306984
20. NIU, F., LIU, J.-M., TAO, L.-M., WANG, W. & SONG, W.-G. Nitrogen and Silica Co-Doped Graphene Nanosheets for NO₂ Gas Sensing. Journal of Materials Chemistry A, vol. 1, no. 20, May 2013, page 6130, ISSN 2050-7488
21. CAO, M., HAN, C., WANG, X., ZHANG, M., ZHANG, Y., SHU, J., YANG, H., FANG, X. & YUAN, J. Graphene Nanohybrids: Excellent Electromagnetic Properties for the Absorbing and Shielding of Electromagnetic Waves. Journal of Materials Chemistry C, vol. 6, no. 17, May 2018, pages 4586-4602, ISSN 2050-7526
22. SMITS, E. C. P., WALTER, A., DE LEEUW, D. M. & ASADI, K. Laser Induced Forward Transfer of Graphene. Applied Physics Letters, vol. 111, no. 17, October 2017, page 173101, ISSN 0003-6951
23. KAULING, A. P., SEEFELDT, A. T., PISONI, D. P., PRADEEP, R. C., BENTINI, R., OLIVEIRA, R. V. B., NOVOSELOV, K. S. & CASTRO NETO, A. H. The Worldwide Graphene Flake Production. Advanced Materials, vol. 30, no. 44, November 2018, page 1803784, ISSN 09359648
24. WO 2018/085789 A1 (WILLIAM MARSH RICE UNIVERSITY, BEN-GURION UNIVERSITY) 11 May 2018, the whole document.
25. PANKRATOV, O., HENSEL, S. & BOCKSTEDTE, M. Electron Spectrum of Epitaxial Graphene Monolayers. Physical Review B, vol. 82, no. 12, September 2010, page 121416, ISSN 1098-0121
26. HASS, J., VARCHON, F., MILLÁN-OTOYA, J. E., SPRINKLE, M., SHARMA, N., DE HEER, W. A., BERGER, C., FIRST, P. N., MAGAUD, L. & CONRAD, E. H. Why Multilayer Graphene on 4H—SiC (0001) Behaves Like a Single Sheet of Graphene. Physical Review Letters, vol. 100, no. 12, March 2008, page 125504, ISSN 0031-9007
27. LUONG, D. X. et al. Gram-Scale Bottom-up Flash Graphene Synthesis. Nature, vol. 577, no. 7792, January 2020, pages 647-651, ISSN 0028-0836
28. CHEN, Y., GONG, X. & GAI, J. Progress and Challenges in Transfer of Large-Area Graphene Films. Advanced Science, vol. 3, no. 8, August 2016, page 1500343, ISSN 2198-3844
29. ORTELLI, E. E., GEIGER, F., LIPPERT, T., WEI, J. & WOKAUN, A. UV-Laser-Induced Decomposition of Kapton Studied by Infrared Spectroscopy. Macromolecules, vol. 33, no. 14, July 2000, pages 5090-5097, ISSN 0024-9297
30. RAO, R., PODILA, R., TSUCHIKAWA, R., KATOCH, J., TISHLER, D., RAO, A. M. & ISHIGAMI, M. Effects of Layer Stacking on the Combination Raman Modes in Graphene. ACS Nano, vol. 5, no. 3, March 2011, pages 1594-1599, ISSN 1936-0851.
31. LOUETTE, P., BODINO, F. & PIREAUX, J. Poly(Dimethyl Siloxane) (PDMS) XPS Reference Core Level and Energy Loss Spectra.” Surface Science Spectra, vol. 12, no. 1, December 2005, pages 38-43, ISSN 1055-5269
32. HIMPSEL, F. J., MCFEELY, F. R., TALEB-IBRAHIMI, A., YARMOFF, J. A. & HOLLINGER, G. “Microscopic Structure Of The SiO2/Si Interface.” The Physics and Chemistry of SiO₂ and the Si—SiO₂ Interface, Springer US, 1988, pages 219-225, ISBN 978-1-4899-0774-5
33. US20200399131A1, (ROYAL MELBOURNE INSTITUTE OF TECHNOLOGY) 24 Dec. 2020, paragraphs [0032], FIG. 13.
34. OLIVEIRA, R. L., OLIVEIRA, C. S., LANDERS, R. & CORREIA, C. R. D. Pd Nanoparticles Immobilized on Graphene Oxide/Silica Nanocomposite: Efficient and Recyclable Catalysts for Cross-Coupling Reactions. ChemistrySelect, vol. 3, no. 2, January 2018, pages 535-543, ISSN 23656549
35. STANFORD, M. G., LI, J. T., CHYAN, Y., WANG, Z., WANG, W. & TOUR, J. M. Laser-Induced Graphene Triboelectric Nanogenerators. ACS Nano, vol. 13, no. 6, June 2019, pages 7166-7174, ISSN 1936-0851.

1. A method of manufacturing a graphene-based film on a substrate, comprising the steps of:
providing a laser source, a target material comprising carbon source which exhibits proper optical absorption at the said laser source wavelength and a target substrate placed at a distance up to 10 cm from the carbon source,
selecting a laser fluence, a pulse duration, a repetition rate of the laser pulse on the target substrate,
exposing the target material to the laser beam pulses to decompose the target material into fragments.
depositing the said fragments on the target substrate,
characterized in that the carbon source contains chemical groups capable of providing propelling gases as a result of the laser assisted violent decomposition, said propelling gases propel the said fragments on to the target substrate.

2. The method according to claim 1, wherein the target material comprising a carbon source and a precursor material, the said precursor material decomposes upon heating or irradiation to metal oxide, metal salt, metal chalcogenide, metal carbide, and/or combination thereof.

3. The method according to claim 1 wherein the carbon source is a polymer and/or an organic compound and/or a biomass-derived product and/or graphene oxide and/or elemental carbon mixed with a precursor producing propelling gases.

4. The method according to claim 1, wherein the carbon source and the precursor are in the form of foils and/or layers and/or powders and/or combinations thereof.

5. The method according to claim 1 wherein the laser source emits radiation with wavelength between 900 nm and 3 μm.

6. The method according claim 1 wherein the laser beam is directed towards the target material from the other side of that facing the target substrate.

7. The method according to claim 1 wherein the laser source is directed towards the target material from the side which is facing the target substrate.

8. The method according to claim 1 wherein the film exhibits turbostratic structure.

9. An electrode for a flexible triboelectric nanogenerator device comprising a layer of a graphene-based film on a substrate manufactured according to claim 1.

10. A flexible triboelectric nanogenerator comprising an electrode according to claim 9 wherein the impedance is equal or lower than 3 MΩ.

11. An electrode for an energy storage system comprising a layer of a graphene-based film on a substrate manufactured according to claim 1.

12. A supercapacitor comprising an electrode according to claim 11.
